(19) United States
(12) Patent Application Publication
(10) Pub. No.: US 2006/0157996 A1
(43) Pub. Date: Jul. 20, 2006

(54) Tongs

(75) Inventors: Robert G. McRorie III, Huntersville, NC (US); Mark A. Stultz, Huntersville, NC (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RUBBERMAID INCORPORATED, Fairlawn, OH (US)

(21) Appl. No.: 11/289,873

(22) Filed: Nov. 30, 2005

Related U.S. Application Data
(60) Provisional application No. 60/633,147, filed on Dec. 3, 2004.
(60) Provisional application No. 60/637,615, filed on Dec. 20, 2004.

(51) Int. Cl. A47G 21/10; A47J 43/28

(52) U.S. Cl. 294/16

(57) ABSTRACT

A pair of tongs includes a first arm, a second arm, and a plastic hinge structure, constructed at least in part from a material different from at least one of the first arm and the second arm, joining the first arm to the second arm. The tongs may further include a steel spring, and the plastic hinge structure may be over molded to cover the steel spring.

### RELATED APPLICATION DATA

This patent is based on and claims priority benefit of U.S. Provisional Patent Application Ser. No. 60/633,147, which was filed on Dec. 3, 2004, and U.S. Provisional Patent Application Ser. No. 60/637,615, which was filed on Dec. 20, 2004, both of which are incorporated herein by reference.

### BACKGROUND OF THE INVENTION

1. Field of the Disclosure

The present disclosure is generally directed to hand operated utensils, and more particularly to tongs.

2. Description of Related Art

Current commercial grade or heavily used tongs that are available on the market have a typical life span of about 6 months or even less. The arms of this type of tong are often C-shaped in cross section, with sidewalls oriented at an acute or in-turned angle to the middle wall. This geometry does not readily facilitate cleaning. Cleaning such tongs may be difficult due to the cross-section profile of the C-shaped stainless steel arms. The C-shaped cross-section carries through to the joint or connection between the two arms. The arms are quite difficult to clean in this region. Traditional, all-stainless steel tongs have a mechanical spring and a riveted hinge. This type of tong usually fails because the spring weakens over repeated use, or because the riveted hinge fails. This type of hinge is also typically not in compliance with National Sanitation Foundation (NSF) International standards.

One-piece stainless steel tongs are known that are more easily cleaned. However, these tongs lack durability and typically cannot survive a commercial kitchen or heavy use environment.

### SUMMARY

In accordance with one aspect of the invention, a pair of tongs includes a first arm, a second arm, and a plastic hinge structure constructed at least in part from a material different from at least one of the first arm and the second arm, joining the first arm to the second arm.

In accordance with another aspect of the invention, at least one of the arms may be constructed from stainless steel, and the plastic hinge structure may serve as a spring and a hinge.

In accordance with another aspect of the invention, a steel strap may serve as a spring.

In accordance with a still further aspect of the invention, the plastic hinge structure may be at least partially formed from an over-molded material, and the over-molded material may be, for example, silicone.

In accordance with yet another aspect of the invention, a method of manufacturing tongs is provided. The method includes: providing a pair of arms; and over molding a plastic material over at least one end of each of the arms to form a hinge structure joining the pair of arms to one another. The arms may be constructed from a metallic material, such as, for example, stainless steel, and the plastic material may be, for example, silicone.

### BRIEF DESCRIPTION OF THE DRAWINGS

Objects, features, and advantages of the present invention will become apparent upon reading the following description in conjunction with the drawing figures, in which:

FIG. 1 is a perspective view from the working end of one example of a pair of tongs constructed in accordance with the teachings of the present invention and in an open condition;

FIG. 2 is a perspective view from the hand grip end of the pair of tongs as shown in FIG. 1 and in the open condition;

FIG. 3 is a plan view of the pair of tongs as shown in FIG. 1 and in the open condition;

FIG. 4 is a perspective view from the working end of another example of a pair of tongs constructed in accordance with the teachings of the present invention and in an open condition;

FIG. 5 is the pair of tongs as shown in FIG. 4 and in a closed condition;

FIG. 6 is a perspective view from the working end of a further example of a pair of tongs constructed in accordance with the teachings of the present invention and in an open condition;

FIG. 7 is a plan view of the pair of tongs as shown in FIG. 6 and in the open condition;

FIG. 8 is an exploded perspective view of the pair of tongs as shown in FIG. 6;

FIG. 9 is a plan view of yet another example of a pair of tongs constructed in accordance with the teachings of the present invention and in an open condition;

FIG. 10 is a perspective view from the working end of yet another example of a pair of tongs constructed in accordance with the teachings of the present invention, in an open condition, before a plastic portion of the tongs is attached;

FIG. 11 is a perspective view from the handle and of the tongs of FIG. 10 after the plastic portion is attached;

FIG. 12 is a side view of the tongs of FIG. 11;

FIG. 13 is a plan view of the tongs of FIG. 11, in a closed condition; and

FIG. 14 is a plan view of the tongs of FIG. 11 in an open condition.

### DETAILED DESCRIPTION OF THE DISCLOSURE

The disclosed utensil solves or improves upon one or more of the problems noted above with prior known utensils. Pairs of tongs are disclosed herein that may have improved durability over prior known tong constructions. Pairs of tongs are disclosed herein that also may be more easily cleanable than prior known tong constructions.

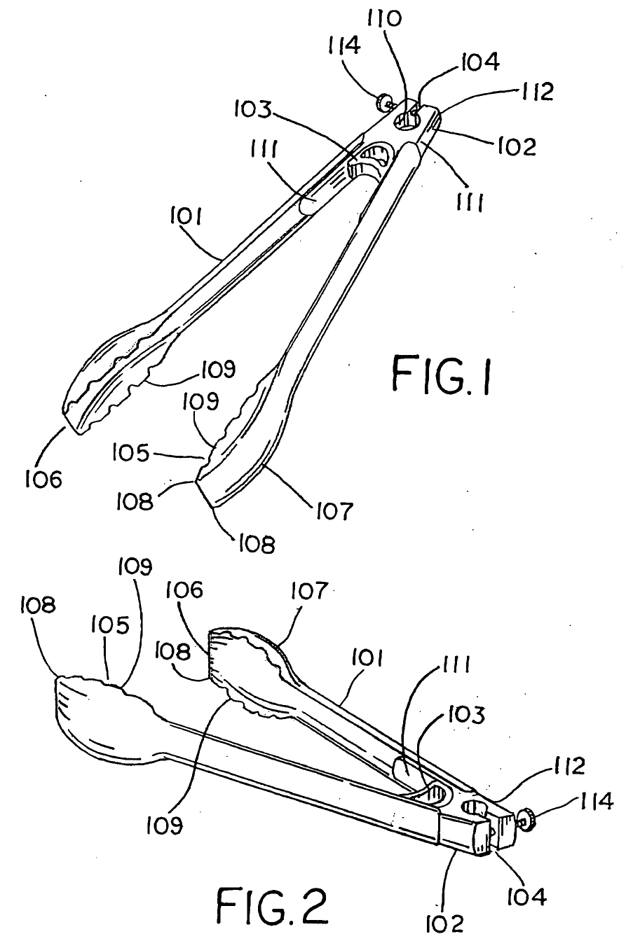

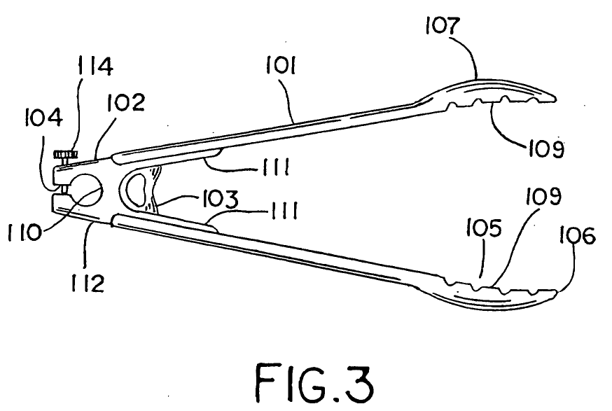

In one example, as shown in FIGS. 1-3, a utensil in the form of a pair of tongs 100 is disclosed that has stainless steel arms 101 with a working end having integral tips 107. The tips 107 are generally designed to optimize three main methods of grabbing food. A first method of grabbing food addressed by the disclosed tongs 100 is to slip a tip 107 of one of the tongs 100 underneath the food like a spatula and then grab the food by closing the tongs 100 from top to bottom onto the food item. A second method of grabbing food addressed by the disclosed tongs 100 is to orient the tongs 100 to grab the food by the opposed sides of a food item. A third method of grabbing food addressed by the disclosed tongs 100 is for finesse use where the forward corners of the tong tips 107 are used to pick up small, delicate food items, such as, for example, asparagus.

The first method may be accomplished by using flattened, linear tip ends 106 for better access underneath the food. The flattened linear tip ends 106 may also be angled so that when the tip 107 is tangent to the cooking surface, the end user's hands are at a safe and comfortable angle from the cooking surface. When the tongs 100 are fully closed, forward corners 108 of the flattened tip ends 106 are the first to engage, as this is where the third (finesse) method may be required. This tong may also be optimized for the second method. For example, sides 109 of the tips 107 may be oriented at a more acute angle than typical tongs in order to better cradle the sides of food. If desired, the sides 109 may be disposed at a 90 degree angle with respect to the tip ends 106. The spooning effect created by this angle may make it easier to support fragile food, such as seared tuna or the like, without crushing it. In addition, the disclosed tongs 100 may include a more aggressive tooth configuration 105 that may be more functional than the softer scallops traditionally available on standard tongs.

The arms 101 in this example may be mechanically fastened to (e.g., using one or more fasteners, such as rivets), or integrally molded within a plastic hinge structure 102. In one example, the hinge structure 102 may be made of engineering grade plastic. There may be a designated flex area or bridge 110 in the hinge structure 102 that extends between two plastic parts or connectors 111 coupled or fastened to the arms 101. The bridge or flex area 110 may have a thin cross section to provide a location where the hinge structure 102 moves, e.g., where the two plastic parts 111 may move relative to one another or rotate. The hinge structure 102 may also include an over-molded, resilient material 103. The over-molded material 103 may be silicone, and may be located or positioned as shown in FIGS. 1-3 so that, when compressed, it may act as a spring to return the tongs 100 to the original opening angle after use. In one example, the opening angle may be about 20 degrees. In the disclosed hinge structure 102, there may be a stop 104 to prevent over-rotation due to abuse. The stop 104 may protect the tongs from breakage due to abuse. The stop 104 in this example is positioned at a hand grip distal end 112 of the tongs 100, longitudinally outward of the flex area or bridge 110.

In one example, a means to adjust the opening angle may be provided to a selected, more comfortable or appropriate angle for each end user. Such adjustability could be in the form of a ‘screw’ or lever in the stop 104 area that allows the user to ‘dial in’ a maximum opening angle, which they would prefer. Such an adjustment means may be in the form of a thumb-screw 114

The components of the disclosed tongs 100 may be manufactured from any suitable materials. In one example, the arms 101 may be formed of stamped stainless steel, such as, for example 304 stainless steel. In one example, the hinge structure 102 may be made from injection molded engineering grade plastic, such as suitable polymers, including Nylon, Delrin, TPV, PC, or the like. In one example, the return spring function may be provided by an over-molded material such as TPE, TPU, TPV, Silicone, or the like, and molded in the hinge structure 102. In an alternative example, an all-plastic tong construction could be utilized, but such a pair of tongs may be less capable of withstanding exposure to high temperatures, for example, such as temperatures associated with grilling and/or baking foods, as compared to steel tongs.

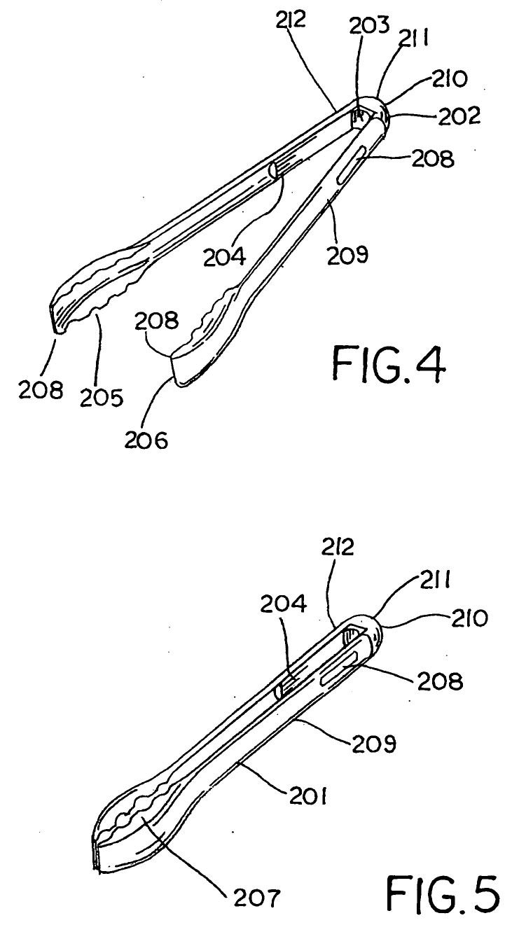

FIGS. 4 and 5 illustrate another example of a pair of tongs 200 constructed in accordance with the teachings of the present invention. In this example, arms 201 of the tongs 200 may be inserted into a mold and a hinge 202 and coupler or connection parts 204 may be over-molded to the arms 201. A through-opening 208 in a wall 209 of each of the arms 201 may receive plastic material of the hinge 202 through the wall 209 to secure or partly secure the hinge 202 to the arms 201. The plastic material through the wall is visible in FIGS. 4 and 5. Additional fasteners may be used to further fix the hinge 202 in place if desired. In this example, a flex area or bridge 210 is positioned at a most distal end 211 of a hand grip end 212 of the tongs and interconnects and continues as extensions of the coupler or connection parts 204.

A resilient, return spring material 203, that may be made from silicone, may be over-molded between the coupler or arm connection parts 204 of the hinge 202. In any of the disclosed examples, the return spring material 203 may be over-molded between the connection parts 204 either with or without a slim layer or band of supporting hinge plastic material also extending between the coupler or connection parts 204 and the return spring material 203 may be molded within the resilient spring material band. The arms 201; tips 207, including flattened tip ends 206 and teeth 205, in this example may be essentially the same as those of the previous example.

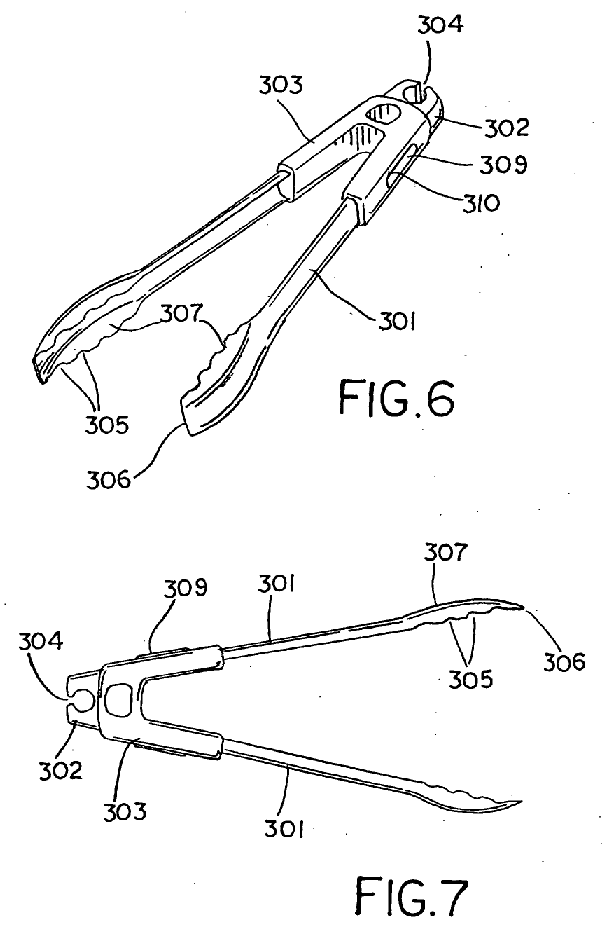

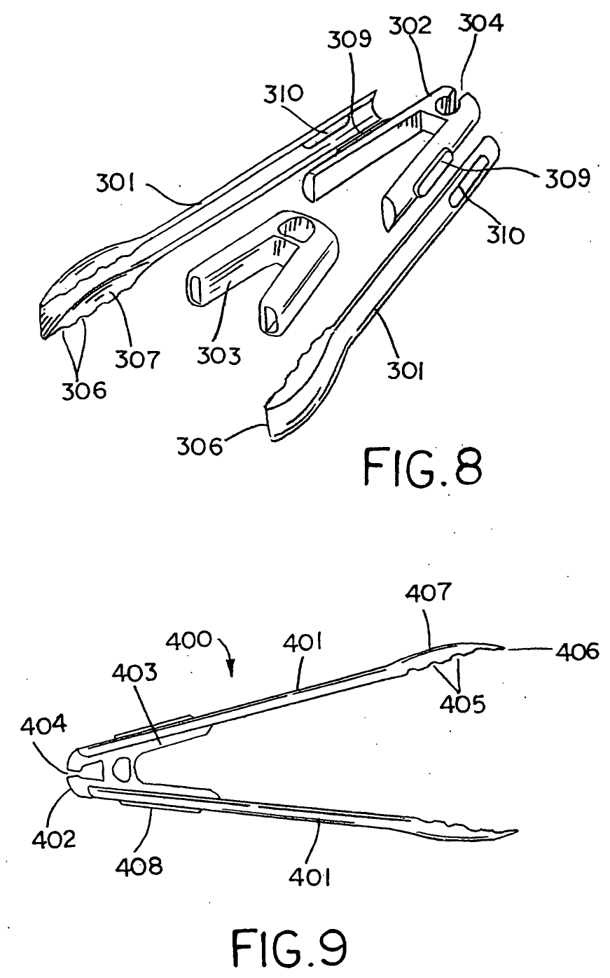

In yet another example, as shown in FIGS. 6-8, a utensil in the form of a pair of tongs 300 is disclosed that has arms 301 with a working end having integral tips 307. The tips 307 may include flattened tip ends 306 and teeth 305, in this example that are essentially the same as those of the previous examples. The arms 301 may be made from stainless steel, such as, for example 304 stainless steel, and may be attached to a hinge 302 by snap-fitting a protruding portion 309 of the hinge 302 into an opening 310 provided on each arm 301. Alternatively, the arms 301 may be attached to the hinge 302 by injection molding the hinge 302 around the arms 301.

A resilient, return spring material 303 may be over-molded around the arms 301 and the hinge 302, and may provide a mechanical bond, securing the hinge 302 to the arms 301, as well as acting as a spring. The over-molded return spring material 303 may be silicone material and may also act as a grip. The return spring material 303 may mechanically bond to both the hinge 302 and to the arms 301. This means the return spring material 303 may act as the ‘glue’ that holds the arms 301 and the hinge 302 together, as well as acting as the spring.

As shown in FIG. 9, another example of tongs 400 may include a hinge 402 that may be sonically bonded (e.g., using ultrasonic bonding) and/or heat staked to arms 401, that may be formed from stainless steel, such as, for example 304 stainless steel. Subsequently, a distal portion 405 of the tongs 400 may be over-molded to include a spring material 403, that also may be over-molded to cover the area at which the hinge 402 is either sonically bonded or heat staked to the arms 401. The spring material 403 may be silicone material and may also act as a grip.

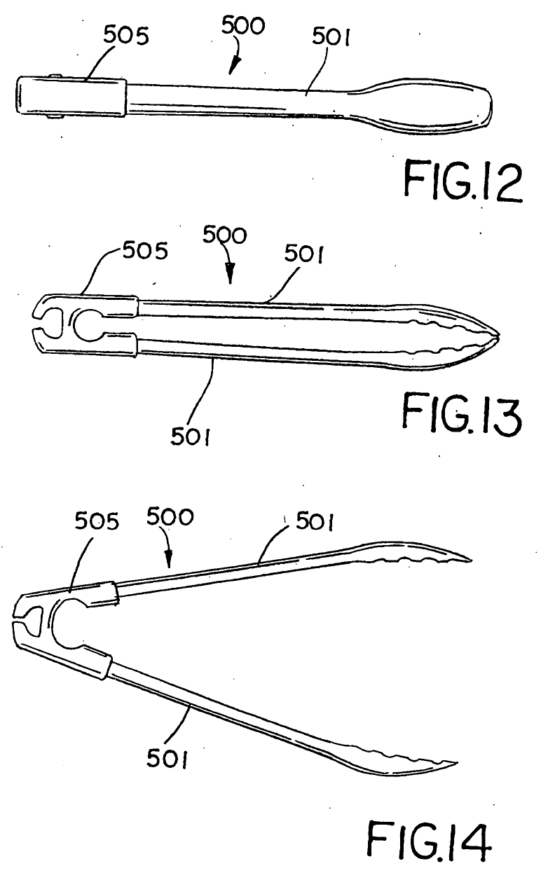

As shown in FIGS. 10-14, yet another example of tongs 500 may include stainless steel arms 501, that are connected by a stainless steel or spring steel strap 503 that may be pre-formed, and then either riveted, spot welded, or tack-welded into position between the arms 501. The steel arms 501 may be made from, for example 304 stainless steel. The spring steel strap 503 may be made from spring steel or hardened steel, such as, for example, 301-1/2 hard stainless steel, and may alternatively be a torsional spring.

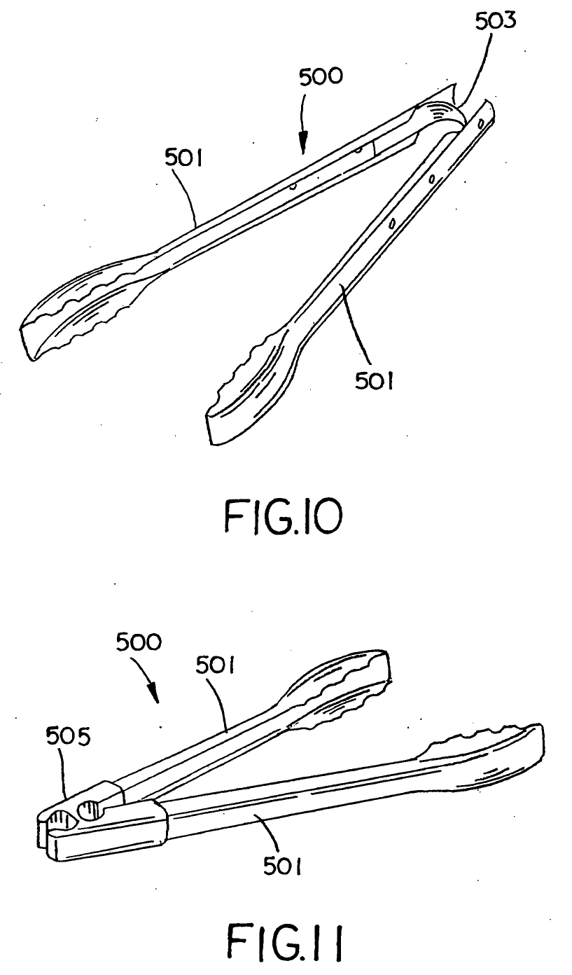

As shown in FIGS. 11-14, a plastic over mold portion 505 may be over molded on the arms 501 and the steel strap 503 in order to seal the hinge end of the tongs 500, to make the tongs NSF compliant by virtue of their clean-ability. The plastic over mold portion 505 may be made from any suitable material, such as, for example, GE LSR 2670. A primer, such as, for example, Wacker G790 primer, may be used to ensure a secure bond between the over mold portion 505 and the steel strap 503 and the arms 501.

The use of such a configuration as compared to a one-piece stainless steel pair of tongs is that the spring steel that may be used for the steel strap 503 will have a longer life and will provide the flex and spring that the end user desires. The pair of tongs 500 will provide an NSF compliant tong that has the spring qualities of a traditional pinned-hinge pair of tongs.

The disclosed tongs may utilize a plastic hinge that is over-molded over stainless steel arms. The way the hinge is molded facilitates the spring without any moving parts. This type of hinge (and therefore the tongs) will be NSF compliant. There may be cost disadvantages by the addition of the plastic parts and added assembly. However, the addition of NSF compliance and the added clean-ability should outweigh the cost increase.

Although certain tong constructions have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A pair of tongs comprising:
a first arm;
a second arm; and
a plastic hinge structure constructed at least in part from a material different from at least one of the first arm and the second arm, joining the first arm to the second arm.

2. The tongs according to claim 1, wherein at least one of the arms is constructed from stainless steel.

3. The tongs according to claim 1, wherein the plastic hinge structure serves as a spring and a hinge.

4. The tongs according to claim 1, further including a steel strap that serves as a spring.

5. The tongs according to claim 1, wherein the plastic hinge structure is at least partially formed from an over-molded material.

6. The tongs according to claim 5, wherein the over-molded material is silicone.

7. A method of manufacturing tongs, the method comprising:
providing a pair of arms; and
over molding a plastic material over at least one end of each of the arms to form a hinge structure joining the pair of arms to one another.

8. The method of claim 7, wherein the arms are constructed from a metallic material.

9. The method of claim 8, wherein the metallic material is stainless steel.

10. The method of claim 7, wherein the plastic material is silicone.
